(19) United States
(12) Patent Application Publication
(10) Pub. No.: US 2026/0195706 A1
(43) Pub. Date: Jul. 9, 2026

(54) DETECTING DEBRIS ON A GRID OF A STORAGE SYSTEM

(71) Applicant: Ocado Innovation Limited, Hatfield (GB)

(72) Inventors: Daniel James MANNION, Cambridge (GB); Daniel Edward RICHARDS, London (GB); Peter David WILSON, Ipswich (GB)

(21) Appl. No.: 19/133,484

(22) PCT Filed: Nov. 30, 2023
(86) PCT No.: PCT/EP2023/083820

§ 371 Date: May 28, 2025

(30) Foreign Application Priority Data
Nov. 30, 2022 (GB) 2218003.8

(51) Int. Cl. G06Q 10/087

(52) U.S. Cl. CPC G06Q 10/087

(57) ABSTRACT

A detection system and method for detecting debris in a workspace comprising a grid formed by a first set of tracks extending in a first direction and a second set of tracks extending in a second direction transverse to the first direction. The method involves obtaining image data, representative of an image of at least part of the workspace, and processing it with an object detection model trained to detect instances of debris on the grid. It is determined, based on the processing, whether the image includes debris on the grid. Annotation data, indicative of the debris in the image, is output in response to determining that the image includes debris on the grid.

### TECHNICAL FIELD

The present disclosure generally relates to the field of a storage or fulfilment system in which stacks of bins or containers are arranged within a grid framework structure, and more specifically, to detecting debris on the grid framework structure.

### BACKGROUND

Online retail businesses selling multiple product lines, such as online grocers and supermarkets, require systems that can store tens or hundreds of thousands of different product lines. The use of single-product stacks in such cases can be impractical since a vast floor area would be required to accommodate all of the stacks required. Furthermore, it can be desirable to store small quantities of some items, such as perishables or infrequently ordered goods, making single-product stacks an inefficient solution.

PCT Publication No. WO2015/185628A (Ocado) describes a further known storage and fulfilment system in which stacks of containers are arranged within a grid framework structure. The containers are accessed by one or more load handling devices, otherwise known as robots or “bots”, operative on tracks located on the top of the grid framework structure. A system of this type is illustrated schematically in FIGS. 1 to 3 of the accompanying drawings.

As shown in FIGS. 1 and 2, stackable containers 10, also known as “bins”, are stacked on top of one another to form stacks 12. The stacks 12 are arranged in a grid framework structure 14, e.g. in a warehousing or manufacturing environment. The grid framework structure 14 is made up of a plurality of storage columns or grid columns. Each grid in the grid framework structure has at least one grid column to store a stack of containers. FIG. 1 is a schematic perspective view of the grid framework structure 14, and FIG. 2 is a schematic top-down view showing a stack 12 of bins 10 arranged within the framework structure 14. Each bin 10 typically holds a plurality of product items (not shown). The product items within a bin 10 may be identical or different product types depending on the application.

The grid framework structure 14 comprises a plurality of upright members 16 that support horizontal members 18, 20. A first set of parallel horizontal grid members 18 is arranged perpendicularly to a second set of parallel horizontal members 20 in a grid pattern to form a horizontal grid structure 15 supported by the upright members 16. The members 16, 18, 20 are typically manufactured from metal. The bins 10 are stacked between the members 16, 18, 20 of the grid framework structure 14, so that the grid framework structure 14 guards against horizontal movement of the stacks 12 of bins 10 and guides the vertical movement of the bins 10.

The top level of the grid framework structure 14 comprises a grid or grid structure 15, including rails 22 arranged in a grid pattern across the top of the stacks 12. Referring to FIG. 3, the rails or tracks 22 guide a plurality of load handling devices 30. A first set 22a of parallel tracks or rails 22 guides movement of the robotic load handling devices 30 in a first direction (e.g. an X-direction) across the top of the grid framework structure 14. A second set 22b of parallel tracks or rails 22, arranged perpendicular to the first set 22a, guides movement of the load handling devices 30 in a second direction (e.g. a Y-direction), perpendicular to the first direction. In this way, the tracks or rails 22 allow the robotic load handling devices 30 to move laterally in two dimensions in the horizontal X-Y plane. A load handling device 30 can be moved into position above any of the stacks 12.

A known form of load handling device 30—shown in FIGS. 4 and 5—is described in PCT Patent Publication No. WO2015/019055 (Ocado), hereby incorporated by reference, where each load handling device 30 covers a single grid space 17 of the grid framework structure 14. This arrangement allows a higher density of load handlers and thus a higher throughput for a given sized storage system.

The example load handling device 30 comprises a vehicle 32, which is arranged to travel on the rails 22 of the frame structure 14. A first set of wheels 34, consisting of a pair of wheels 34 at the front of the vehicle 32 and a pair of wheels 34 at the back of the vehicle 32, is arranged to engage with two adjacent rails of the first set 22a of rails 22. Similarly, a second set of wheels 36, consisting of a pair of wheels 36 at each side of the vehicle 32, is arranged to engage with two adjacent rails of the second set 22b of rails 22. Each set of wheels 34, 36 can be lifted and lowered so that either the first set of wheels 34 or the second set of wheels 36 is engaged with the respective set of rails 22a, 22b at any one time during movement of the load handling device 30. For example, when the first set of wheels 34 is engaged with the first set of rails 22a and the second set of wheels 36 is lifted clear from the rails 22, the first set of wheels 34 can be driven, by way of a drive mechanism (not shown) housed in the vehicle 32, to move the load handling device 30 in the X-direction. To achieve movement in the Y-direction, the first set of wheels 34 is lifted clear of the rails 22, and the second set of wheels 36 is lowered into engagement with the second set 22b of rails 22. The drive mechanism can then be used to drive the second set of wheels 36 to move the load handling device 30 in the Y-direction.

The load handling device 30 is equipped with a lifting mechanism, e.g. a crane mechanism, to lift a storage container from above. The lifting mechanism comprises a winch tether or cable 38 wound on a spool or reel (not shown) and a gripper device 39. The lifting mechanism shown in FIGS. 4 and 5 comprises a set of four lifting tethers 38 extending in a vertical direction. The tethers 38 are connected at or near the respective four corners of the gripper device 39, e.g. a lifting frame, for releasable connection to a storage container 10. For example, a respective tether 38 is arranged at or near each of the four corners of the lifting frame 39. The gripper device 39 is configured to releasably grip the top of a storage container 10 to lift it from a stack of containers in a storage system 1 of the type shown in FIGS. 1 and 2. For example, the lifting frame 39 may include pins (not shown) that mate with corresponding holes (not shown) in the rim that forms the top surface of bin 10, and sliding clips (not shown) that are engageable with the rim to grip the bin 10. The clips are driven to engage with the bin 10 by a suitable drive mechanism housed within the lifting frame 39, powered and controlled by signals carried through the cables 38 themselves or a separate control cable (not shown).

To remove a bin 10 from the top of a stack 12, the load handling device 30 is first moved in the X- and Y-directions to position the gripper device 39 above the stack 12. The gripper device 39 is then lowered vertically in the Z-direction to engage with the bin 10 on the top of the stack 12, as shown in FIGS. 4 and 6B. The gripper device 39 grips the bin 10, and is then pulled upwards by the cables 38, with the bin 10 attached. At the top of its vertical travel, the bin 10 is held above the rails 22 accommodated within the vehicle body 32. In this way, the load handling device 30 can be moved to a different position in the X-Y plane, carrying the bin 10 along with it, to transport the bin 10 to another location. On reaching the target location (e.g. another stack 12, an access point in the storage system, or a conveyor belt) the bin or container 10 can be lowered from the container receiving portion and released from the grabber device 39. The cables 38 are long enough to allow the load handling device 30 to retrieve and place bins from any level of a stack 12, e.g. including the floor level.

As shown in FIG. 3, a plurality of load handling devices 30 is provided so that each load handling device 30 can operate simultaneously to increase the system's throughput. The system illustrated in FIG. 3 may include specific locations, known as ports, at which bins 10 can be transferred into or out of the system. An additional conveyor system (not shown) is associated with each port so that bins 10 transported to a port by a load handling device 30 can be transferred to another location by the conveyor system, such as a picking station (not shown). Similarly, bins 10 can be moved by the conveyor system to a port from an external location, for example, to a bin-filling station (not shown), and transported to a stack 12 by the load handling devices 30 to replenish the stock in the system.

Each load handling device 30 can lift and move one bin 10 at a time. The load handling device 30 has a container-receiving cavity or recess 40, in its lower part. The recess 40 is sized to accommodate the container 10 when lifted by the lifting mechanism 38, 39, as shown in FIGS. 6A and 6B. When in the recess, the container 10 is lifted clear of the rails 22 beneath, so that the vehicle 32 can move laterally to a different grid location.

If it is necessary to retrieve a bin 10b (“target bin”) that is not located on the top of a stack 12, then the overlying bins 10a (“non-target bins”) must first be moved to allow access to the target bin 10b. This is achieved by an operation referred to hereafter as “digging”. Referring to FIG. 3, during a digging operation, one of the load handling devices 30 lifts each non-target bin 10a sequentially from the stack 12 containing the target bin 10b and places it in a vacant position within another stack 12. The target bin 10b can then be accessed by the load handling device 30 and moved to a port for further transportation.

Each load handling device 30 is remotely operable under the control of a central computer, e.g. a master controller. Each individual bin 10 in the system is also tracked so that the appropriate bins 10 can be retrieved, transported and replaced as necessary. For example, during a digging operation, each non-target bin location is logged so that the non-target bin 10a can be tracked.

Wireless communications and networks may be used to provide the communication infrastructure from the master controller, e.g. via one or more base stations, to one or more load handling devices 30 operative on the grid structure 15. In response to receiving instructions from the master controller, a controller in the load handling device 30 is configured to control various driving mechanisms to control the movement of the load handling device. For example, the load handling device 30 may be instructed to retrieve a container from a target storage column at a particular location on the grid structure 15. The instruction can include various movements in the X-Y plane of the grid structure 15. As previously described, once at the target storage column, the lifting mechanism 38, 39 can be operated to grip and lift the storage container 10. Once the container 10 is accommodated in the container-receiving space 40 of the load handling device 30, it is subsequently transported to another location on the grid structure 15, e.g. a “drop-off port”. At the drop-off port, the container 10 is lowered to a suitable pick station to allow retrieval of any item in the storage container. Movement of the load handling devices 30 on the grid structure 15 can also involve the load handling devices 30 being instructed to move to a charging station, usually located at the periphery of the grid structure 15.

To manoeuvre the load handling devices 30 on the grid structure 15, each of the load handling devices 30 is equipped with motors for driving the wheels 34, 36. The wheels 34, 36 may be driven via one or more belts connected to the wheels or driven individually by a motor integrated into the wheels. For a single-cell load handling device (where the footprint of the load handling device 30 occupies a single grid cell 17), and the motors for driving the wheels can be integrated into the wheels due to the limited availability of space within the vehicle body. For example, the wheels of a single-cell load handling device 30 are driven by respective hub motors. Each hub motor comprises an outer rotor with a plurality of permanent magnets arranged to rotate about a wheel hub comprising coils forming an inner stator.

The system described with reference to FIGS. 1 to 5 has many advantages and is suitable for a wide range of storage and retrieval operations. In particular, it allows very dense storage of products and provides a very economical way of storing a wide range of different items in the bins 10 while also allowing reasonably economical access to all of the bins 10 when required for picking.

With reference to FIG. 6, the system may further comprise a robotic picking station 50 mounted on top of the storage and retrieval structure 1, e.g. alongside the load-handling devices 30 (not shown). The robotic picking station 50 comprises a robotic manipulator 52 comprising a robotic arm 54 and an end effector 56 for releasably engaging a product to be manipulated, together with several designated grid cells 60, 62. The end effector 56 may be a suction device 64 connected to a vacuum source by a vacuum line 66. The robotic manipulator 52 is mounted on a plinth 58 above a single grid cell 60 and, depending on its location on the structure 1, can be surrounded by up to eight other grid cells 62 as shown in FIG. 6. In general, the robotic manipulator 52 is configured to pick an item or product from any one of the containers located in one of the designated grid cells 62 and place it in a container located in another of the designated grid cells 62. The load-handling devices collect containers from, and deliver them to, the designated grid cells 62 as necessary. In this way, the robotic picking station 50 and the load-handling devices 30 work in conjunction to fulfil a customer order or redistribute products throughout the storage and retrieval system 1.

### SUMMARY

There is provided a method of detecting debris in a workspace comprising a grid formed by a first set of tracks extending in a first direction and a second set of tracks extending in a second direction transverse to the first direction, the method comprising: obtaining image data representative of an image of at least part of the workspace; processing the image data with an object detection model trained to detect instances of debris on the grid; determining, based on the processing, whether the image includes debris on the grid; and in response to determining that the image includes debris on the grid, outputting annotation data indicative of the debris in the image.

Also provided is a data processing apparatus comprising a processor configured to perform the method. Also provided is a computer program comprising instructions which, when the program is executed by a computer, cause the computer to carry out the method. Similarly, a computer-readable storage medium is provided which comprises instructions that, when executed by a computer, cause the computer to carry out the method.

Further provided is a system to detect debris in a workspace comprising a grid formed by a first set of tracks extending in a first direction and a second set of tracks extending in a second direction transverse to the first direction, the detection system comprising: an image sensor to capture an image of at least part of the workspace; and an object detection model trained to detect instances of debris on the grid; wherein the detection system is configured to: obtain image data representative of the image; process the image data with the object detection model; determine, based on the processing, whether the image includes debris on the grid; and output, in response to determining that the image includes debris on the grid, annotation data indicating the debris in the image.

In general terms, this description introduces systems and methods to detect debris on the grid structure of a grid-based storage system using a trained object detection model. This allows the grid structure to be monitored for debris, for example, and locations of the detected debris to be determined. Thus, the systems and methods allow for the position of debris on the grid structure to be determined so that action can be taken, e.g. to limit the movement of transport devices on the grid so as to avoid the detected debris and/or to clear up the debris so that the storage system can return to full functionality.

### BRIEF DESCRIPTION OF THE DRAWINGS

Embodiments will now be described by way of example only with reference to the accompanying drawings, in which like reference numbers designate the same or corresponding parts, and in which:

FIG. 1 shows a schematic depiction of an automated storage and retrieval structure;

FIG. 2 shows a schematic depiction of a plan view of a section of track structure forming part of the storage structure of FIG. 1;

FIG. 3 shows a schematic depiction of a plurality of load-handling devices moving on top of the storage structure of FIG. 1;

FIGS. 4 and 5 show a schematic depiction of a load-handling device interacting with a container;

FIG. 6 shows a schematic depiction of a known robotic picking station;

FIGS. 7A and 7B are schematic diagrams of a storage system with a camera positioned above the grid framework structure as part of a detection system according to embodiments;

FIG. 8 is a schematic representation of an image captured by the camera positioned above the grid framework structure according to a specific embodiment;

FIG. 9 is a schematic diagram of a neural network;

FIGS. 10A and 10B are schematic diagrams of a generated model of the tracks of the grid framework structure;

FIG. 11 is a schematic diagram showing a flattening of a captured image of the grid framework structure;

FIG. 12 is a schematic diagram demonstrating the processing of a captured image of the grid framework structure according to embodiments; and

FIG. 13 shows a flowchart depicting a method of detecting debris on a grid forming part of a grid-based storage system according to embodiments.

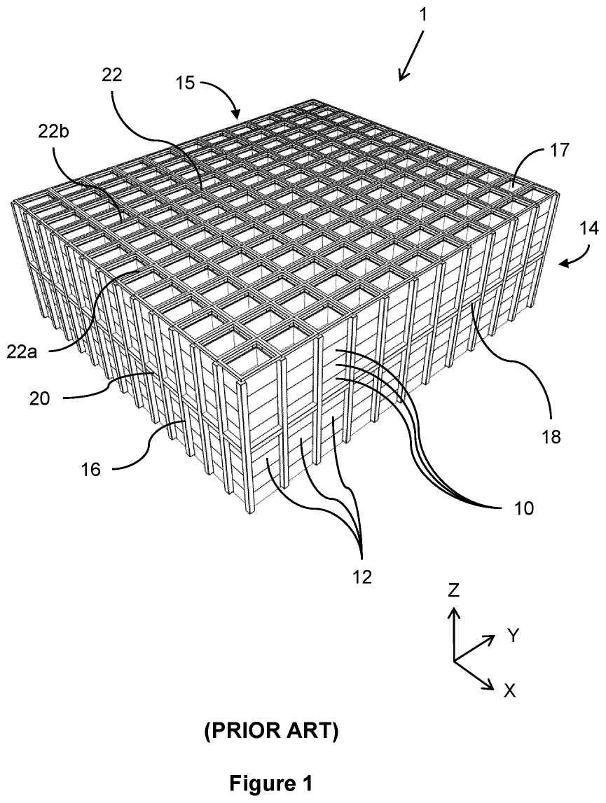

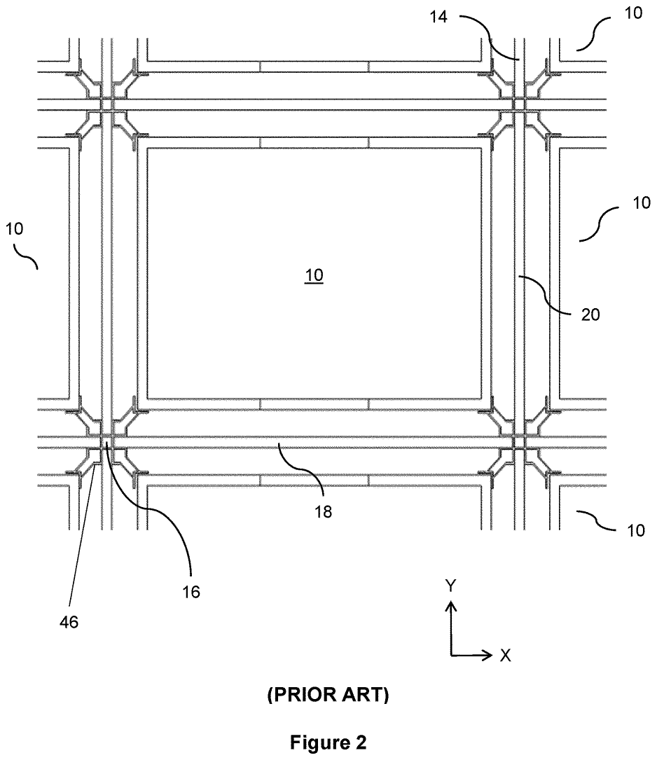

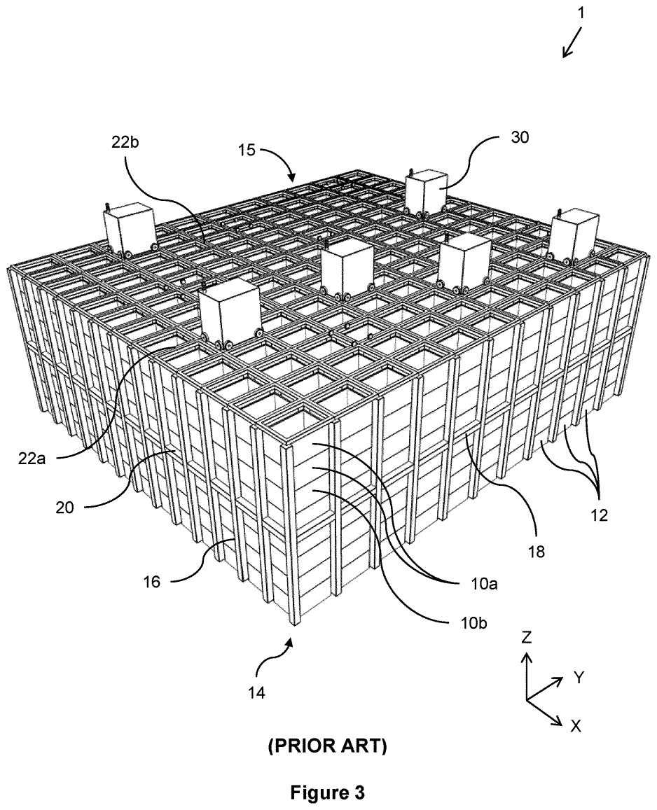

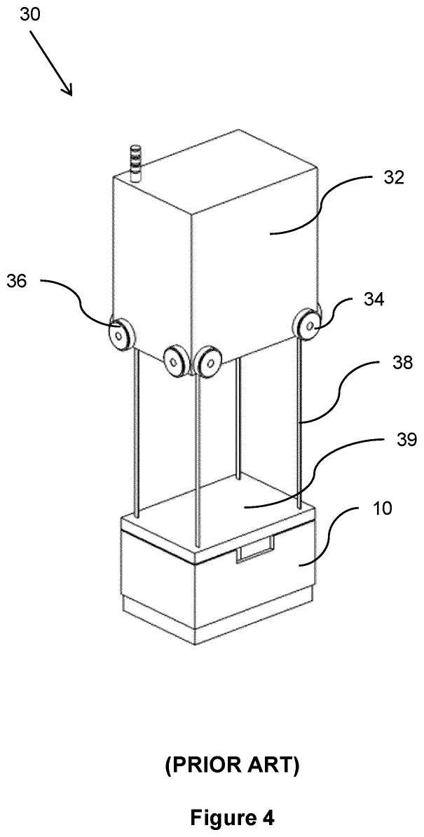

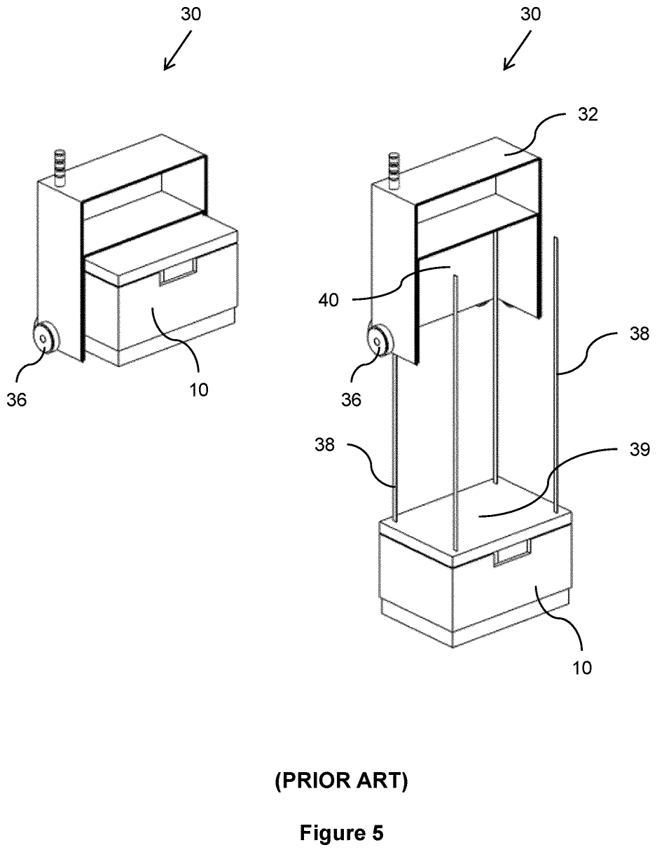

### DETAILED DESCRIPTION

Monitoring the grid structure 15 of a grid-based storage system to detect debris (e.g. one or more discarded or scattered pieces of material) can reduce the likelihood of transport devices encountering the debris. For example, debris on the grid may hinder a transport device, potentially causing the transport device to come off the tracks or otherwise lose control if its movement on the tracks. Liquid debris may cause the transport device to slip on the tracks, for example. Alternatively, the debris may provide resistance to the movement of the transport device on the tracks, potentially causing problems with the control of its movement (e.g. by a master controller). Detection and localisation of debris on the grid 15 can therefore be used to help in clearing the debris, e.g. manually or by a specialised robotic device, or at least prevent transport devices coming into contact with the debris while it is present on the grid.

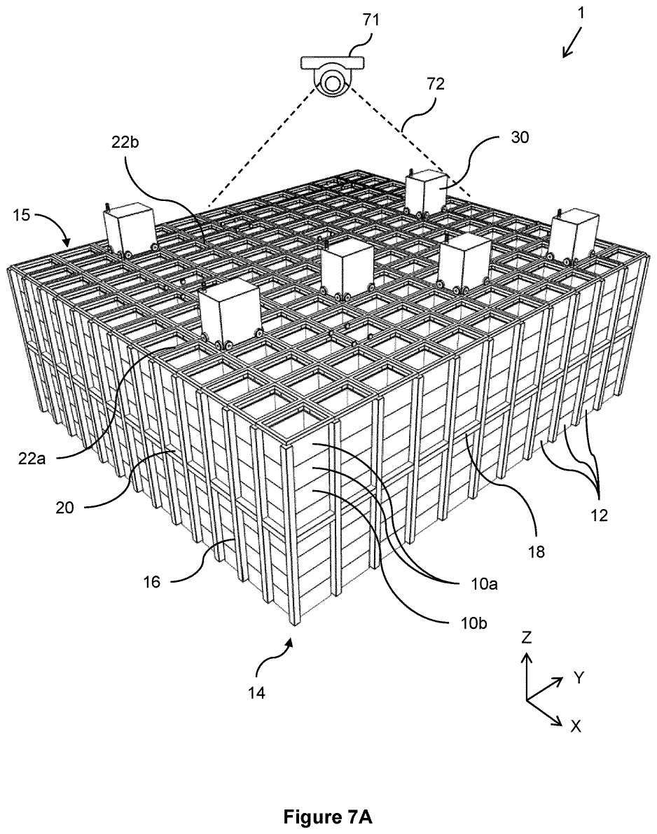

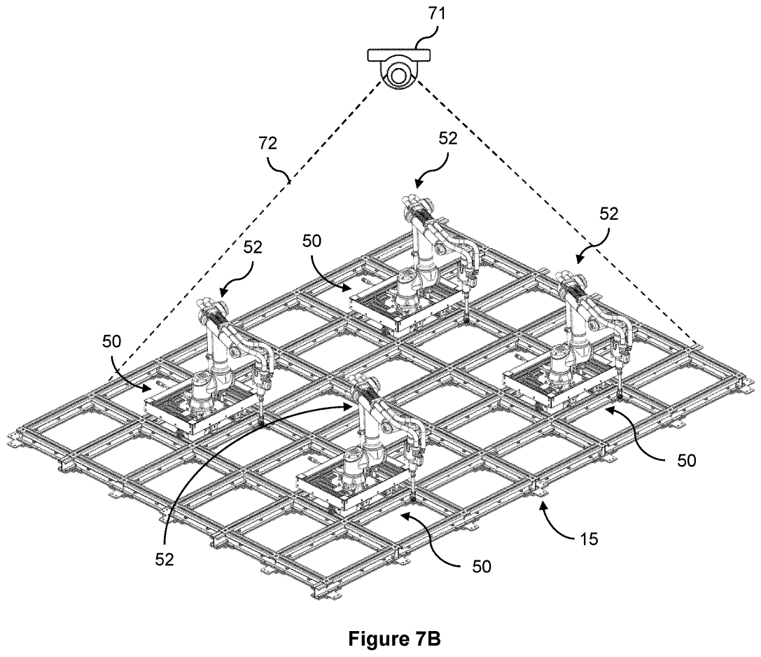

FIG. 7A shows the grid structure (or simply “grid”) 15 of a storage system, as previously described. The grid is formed by a first set of parallel tracks 22a extending in an X-direction and a second set of parallel tracks 22b extending in a Y-direction, transverse to the first set in a substantially horizontal plane. The grid 15 has a plurality of grid spaces 17. One or more load handling devices, or “transport devices” 30, are arranged to selectively move in at least one of the X-direction or Y-direction on the tracks 22, and to handle a container 10 stacked beneath the tracks 22 within a footprint of a single grid space 17. In examples, the one or more transport devices 30 each has a footprint that also occupies only a single grid space, such that a given transport device occupying one grid space does not obstruct another transport device occupying or traversing adjacent grid spaces.

Disposed above the grid 15 is a camera 71. In examples, the camera 71 is an ultra wide-angle camera, i.e. comprises an ultra wide-angle lens (also referred to as a “super wide-angle” or “fisheye” lens). The camera 71 includes an image sensor to receive incident light that is focused through a lens, e.g. the fisheye lens. The camera 71 has a field of view 72 including at least a section of the grid 15. Multiple cameras may be used to observe the entire grid 15, e.g. with each camera 71 having a respective field of view 72 covering a section of the grid 15. The ultra wide-angle lens may be selected for its relatively large field of view 72, e.g. up to a 180-degree solid angle, compared to other lens types, meaning fewer cameras are needed to cover the grid 15. Space may also be limited between the top of the grid 15 and a surrounding structure, e.g. a warehouse roof, thus constraining the height of the camera 71 above the grid 15. An ultra wide-lens camera can provide a relatively large field of view at a relatively low height above the grid 15 compared to other camera types.

The one or more cameras 71 can be used to monitor a workspace of the transport devices 30, the workspace including the grid structure 15. For example, an image feed from the one or more cameras 71 can be obtained for processing the image data to detect debris in the workspace which may hinder the transport devices 30 when moving on the grid 15. The image feed may simultaneously be displayed on one or more remote computer monitors for manual surveillance of the grid 15, e.g. by an operator.

### Calibration Process

A monitoring or surveillance system for the grid 15 may incorporate calibration of the one or more cameras 71 positioned above the grid 15, particularly in embodiments comprising wide-angle or ultra wide-angle cameras. Accurate calibration of the (ultra) wide-angle cameras may allow for interaction with the images captured thereby, which are distorted by the (ultra) wide-angle lens, to be mapped correctly to the workspace. Thus, selected areas of pixels in the distorted images can be mapped to corresponding areas of grid spaces, for example.

An example calibration process for an ultra wide-angle camera includes obtaining an image of a section of the grid, i.e. a grid section, captured by the camera. Obtaining the image includes obtaining, e.g. receiving, image data representative of the image, e.g. at a processor. For example, the image data may be received via an interface, e.g. a camera serial interface (CSI). An image signal processor (ISP) may perform initial processing of the image data, e.g. saturation correction, renormalization, white balance adjustment and/or demosaicing, to prepare the image data for display.

Initial values of a plurality of parameters corresponding to the ultra wide-angle camera are also obtained. The parameters include a focal length of the ultra wide-angle camera, a translational vector representative of a position of the ultra wide-angle camera above the grid section, and a rotational vector representative of a tilt and rotation of the ultra wide-angle camera. These parameters are usable in a mapping algorithm for mapping pixels in an image distorted by the ultra wide-angle lens of the camera to a plane oriented with the orthogonal grid 15 of the storage system. The mapping algorithm is described in more detail below.

The calibration process includes processing the image using a neural network trained to detect/predict the tracks in images of grid sections captured by ultra wide-angle cameras.

### Neural Network

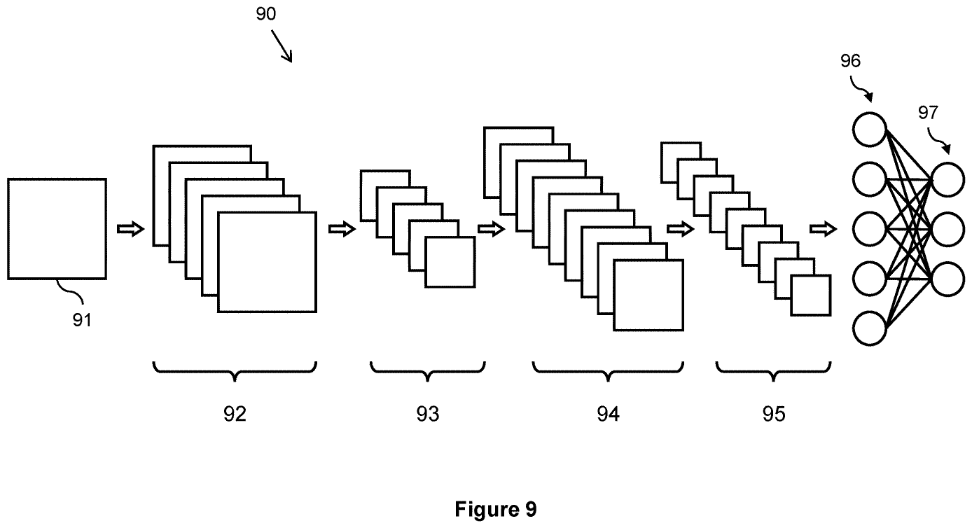

FIG. 9 shows an example of a neural network architecture. The example neural network 90 is a convolutional neural network (CNN). An example of a CNN is the U-Net architecture developed by the Computer Science Department of the University of Freiburg, although other CNNs are usable e.g. the VGG-16 CNN. An input 91 to the CNN 90 comprises image data in this example. The input image data 91 is a given number of pixels wide and a given number of pixels high and includes one or more colour channels (e.g. red, green and blue colour channels).

Convolutional layers 92, 94 of the CNN 90 typically extract particular features from the input data 91, to create feature maps, and may operate on small portions of an image. Fully connected layers 96 use the feature maps to determine an output 97, e.g. classification data specifying a class of objects predicted to be present in the input image 91.

In the example of FIG. 9, the output of the first convolutional layer 92 undergoes pooling at a pooling layer 93 before being input to the second convolutional layer 94. Pooling, for example, allows values for a region of an image or a feature map to be aggregated or combined, e.g. by taking the highest value within a region. For example, with 2×2 max pooling, the highest value of the output of the first convolutional layer 92 within a 2×2 pixel patch of the feature map output from the first convolutional layer 92 is used as the input to the second convolutional layer 94, rather than transferring the entire output. Thus, pooling can reduce the amount of computation for subsequent layers of the neural network 90. The effect of pooling is shown schematically in FIG. 9 as a reduction in size of the frames in the relevant layers. Further pooling is performed between the second convolutional layer 94 and the fully connected layer 96 at a second pooling layer 95. It is to be appreciated that the schematic representation of the neural network 90 in FIG. 9 has been greatly simplified for ease of illustration; typical neural networks may be significantly more complex.

In general, neural networks such as the neural network 90 of FIG. 9 may undergo what is referred to as a “training phase”, in which the neural network is trained for a particular purpose. A neural network typically includes layers of interconnected artificial neurons forming a directed, weighted graph in which vertices (corresponding to neurons) or edges (corresponding to connections) of the graph are associated with weights, respectively. The weights may be adjusted throughout training, altering the output of individual neurons and hence of the neural network as a whole. In a CNN, a fully connected layer 96 typically connects every neuron in one layer to every neuron in another layer, and may therefore be used to identify overall characteristics of an image, such as whether the image includes an object of a particular class, or a particular instance belonging to the particular class.

In the present context, the neural network 90 is trained to perform object identification by processing image data, e.g. to determine whether an object of a predetermined class of objects is present in the image (although in other examples the neural network 90 may have been trained to identify other image characteristics of the image instead). Training the neural network 90 in this way for example generates weight data representative of weights to be applied to image data (for example with different weights being associated with different respective layers of a multi-layer neural network architecture). Each of these weights is multiplied by a corresponding pixel value of an image patch, for example, to convolve a kernel of weights with the image patch.

Specific to the context of ultra wide-angle camera calibration, the neural network 90 is trained with a training set of input images of grid sections captured by ultra wide-angle cameras to detect the tracks 22 of the grid 15 in a given image of a grid section. In examples, the training set includes mask images, showing the extracted track features only, corresponding to the input images. For example, the mask images are manually produced. The mask images can thus act as a desired result for the neural network 90 to train with using the training set of images. Once trained, the neural network 90 can be used to detect the tracks 22 in images of at least part of the grid structure 15 captured by an ultra wide-angle camera.

The calibration process 130 includes processing 133 the image of the grid section captured by the ultra wide-angle camera 71 with the trained neural network 90 to detect the tracks 22 in the image. At least one processor (e.g. a neural network accelerator) may be used to do the processing 133. The image processing 133 generates a model of the tracks, specifically the first and second sets of parallel tracks, as captured in the image of the grid section. For example, the model comprises a representation of a prediction of the tracks in the distorted image of the grid section as determined by the neural network 90. The model of the tracks corresponds to a mask or probability map in examples.

Selected pixels in the determined track model are then mapped 134 to corresponding points on the grid 15 using a mapping, e.g. a mapping algorithm, which incorporates the plurality of parameters corresponding to the ultra wide-angle camera. The obtained initial values are used as inputs to the mapping algorithm.

An error function (or “loss function”) is determined 135 based on a discrepancy between the mapped grid coordinates and “true”, e.g. known, grid coordinates of the points corresponding to the selected pixels. For example, a selected pixel located at the centre of an X-direction track 22a should correspond to a grid coordinate with a half-integer value in the Y-direction, e.g. (x, y.5) where the x is an unknown number and y is an unknown integer. Similarly, a selected pixel located at the centre of an Y-direction track 22b should correspond to a grid coordinate with a half-integer value in the X-direction, e.g. (x′.5, y′) where x′ is an unknown integer and y′ is an unknown number. In examples, the width and length of the grid cells (or a ratio thereof) is used in the loss function, e.g. to calculate the cell x, y coordinate for key points and check whether they are on a track (e.g. a coordinate value of n.5 where n is an integer).

The initial values of the plurality of parameters corresponding to the ultra wide-angle camera are then updated 136 to updated values based on the determined error function. For example, a Broyden-Fletcher-Goldfarb-Shanno (BFGS) algorithm is applied using the error function and initial parameter values as inputs. In examples, the updated values of the plurality of parameters are iteratively determined, with the error function being recalculated with each update. The iterations may continue until the error function is reduced by less than a predetermined threshold, e.g. between successive iterations or compared to the initial error function, or until an absolute value of the error function falls below a predetermined threshold. Other iterative algorithms, e.g. sequential quadratic programming (SQP) or sequential least-squares quadratic programming (SLSQP), can be used with the initial values to generate a sequence of improving approximate solutions for the plurality of parameters, in which a given approximation in the sequence is derived from the previous ones. In certain cases, the iterative algorithm is used to optimise the values of the plurality of parameters. For example, the updated values are optimised values of the plurality of parameters.

The updating 136 of the initial values of the plurality of parameters corresponding to the ultra wide-angle camera involves applying one or more respective boundary values for the plurality of parameters. For example, the boundary values for a rotation angle associated with the rotation vector are substantially 0 degrees and substantially +5 degrees. Additionally or alternatively, the boundary values for a planar component of the translational vector are +0.6 of a length of a grid cell. Additionally or alternatively, the boundary values for a height component of the translational vector are 1800 mm and 2100 mm, or 1950 mm and 2550 mm, or 2000 mm and 2550 mm above the grid. For example, a lower bound for the camera height is in the range 1800 to 2000 mm. For example, an upper bound for the camera height is in the range 2100 to 2600 mm. Additionally or alternatively, the boundary values for the focal length of the camera are 0.23 and 0.26 cm. Applying the one or more respective boundary values for the plurality of parameters can mean that the updating, e.g. optimisation, process is performed in a feasible region or solution space, i.e. a set of all possible values which satisfy the one or more boundary conditions.

The updated values of the plurality of parameters are electronically stored 137 for future mapping of pixels in grid section images captured by the ultra wide-angle camera 71 to corresponding points on the grid 15 via the mapping algorithm. For example, the stored values of the plurality of parameters are retrieved from data storage and used in the mapping algorithm to compute the grid coordinates corresponding to a given pixel in a given image of the grid section captured by the ultra wide-angle camera 71. In examples, the updated values are stored at a storage location, e.g. in a database, associated with the ultra wide-angle camera 71. For example, a lookup function or table may be used with the database to find the stored parameter values associated with any given ultra wide-angle camera employed in the storage system 1 above the grid 15.

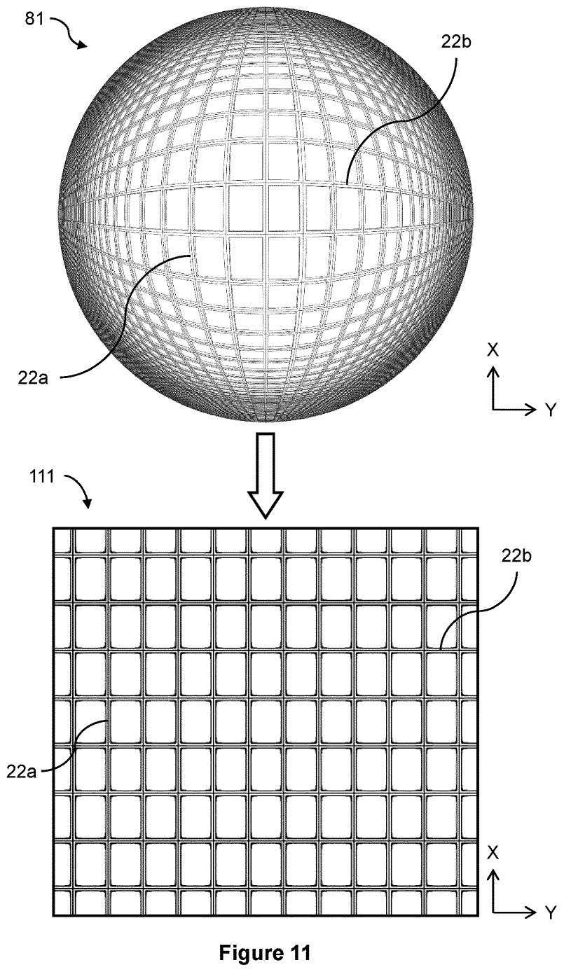

Following calibration of a given camera 71 disposed above the grid 15, an image (e.g. “snapshot”) of a grid section captured by the camera 71 can be flattened, i.e. undistorted, for interaction by an operator. For example, using the image-to-grid mapping function as described, the distorted image 81 of the grid section can be converted into a flattened image 111 of the grid section, as shown in the example of FIG. 11. The flattening involves selecting an area of grid cells to flatten in the distorted image 81, and inputting grid coordinates corresponding to those cells into the mapping function which determines which respective pixel values from the distorted image 81 should be copied into the flattened image 111 for the respective grid coordinates. A target resolution, e.g. in pixels per grid cell, can be set for the flattened image 111, which may have a ratio corresponding to the ratio of the grid cell dimensions. Once all the pixel values needed in the flattened image (per the target resolution and selected number of grid cells) are determined, the flattened image 111 can be generated.

The snapshots may be captured by the camera 71 at predetermined intervals, e.g. every ten seconds, and converted into corresponding flattened images 111. The most recent flattened image 111 is stored in storage for viewing on a display, for example, by an operator wishing to view the grid section covered by the camera 71. The operator may instead choose to retake a snapshot of the grid shot and have it flattened. The operator can thus select regions, e.g. pixels, in the flattened image 111 and have those selected regions converted to grid coordinates based on the image-to-grid mapping function as described herein. In some cases, the flattened image 111 includes annotations of the grid coordinates for the grid spaces viewable in the flattened image 111. The flattened images 111 corresponding to each camera 71 may be more user-friendly for monitoring the grid 15 compared to the distorted images 81, 82.

### Grid to Image Mapping

Mapping real-world points on the grid 15 to pixels in an image captured by a camera is done by a computational algorithm. The grid point is first projected onto a plane corresponding to the ultra wide-angle camera 71. For example, at least one of a rotation using the rotation matrix and a planar translation in the X- and Y-directions is applied to the point having x, y, and z coordinates in the grid framework structure 14. The focal length f of the ultra wide-angle camera may be used to project the point with three-dimensional coordinates relative to the grid 15 onto a two-dimensional plane relative to the ultra wide-angle camera 71. For example, the coordinates of the mapped point q in the plane of the ultra wide-angle camera 71 are calculated as q=f·p_{[x,y]}÷p_{z}, where p_{[x,y]} and p_{z} are the planar x-y coordinates and third z coordinate of the point p relative to the grid 15, respectively.

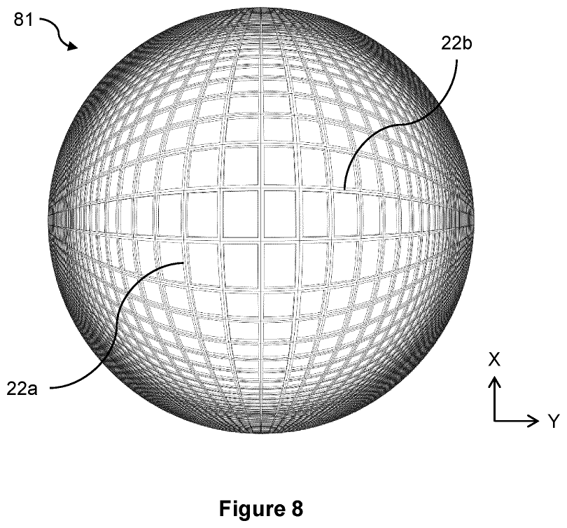

The point q projected onto the ultra wide-angle camera plane may be aligned with a cartesian coordinate system in the plane to determine first cartesian coordinates of the point. For example, aligning the point with the cartesian coordinate system involves rotating the point, or a position vector of the point in the plane (e.g. a vector from the origin to the point). The rotation is thus to align with the typical grid orientation in the images captured by the camera, for example, but may not be necessary if the X- and Y-directions of the grid are already aligned with the captured images. The rotation is substantially 90 degrees in examples. As shown in FIGS. 8A and 8B, the X- and Y-directions of the grid are offset by 90 degrees with respect to the horizontal and vertical axes of the image; thus the rotation “corrects” this offset such that the X- and Y-directions of the grid align with the horizontal and vertical axes of the captured images.

The grid-to-image mapping algorithm continues with converting the first cartesian coordinates into first polar coordinates using standard trigonometric methods. A distortion model is then applied to the first polar coordinates of the point to generate second, e.g. “distorted”, polar coordinates. In examples, the distortion model comprises a tangent model of distortion given by r′=f·arctan(r/f), where r and r′ are the undistorted and distorted radial coordinates of the point, respectively, and f is the focal length of the ultra wide-angle camera.

The second polar coordinates are then converted back into (second) cartesian coordinates using the same standard trigonometric methods in reverse. The image coordinates of the pixel in the image are then determined based on the second cartesian coordinates. In examples, this determination includes at least one of de-centering or re-scaling the second cartesian coordinates. Additionally or alternatively, the ordinate (y-coordinate) of the second cartesian coordinates is inverted, e.g. mirrored in the x-axis.

### Image to Grid Mapping

Mapping pixels in an image captured by the camera 71 to real-world points on the grid 15 is done by a different computational algorithm. For example, the image-to-grid mapping algorithm is an inverse of the grid-to-image mapping algorithm described above, with each mathematical operation being inverted.

For a given pixel in the image, (second) cartesian coordinates of the mapped point are determined based on image coordinates of the pixel in the image. For example, this determination involves initialising the pixel in the image, e.g. including at least one of centering or normalising the image coordinates. As before, the ordinate is inverted in some examples. The second cartesian coordinates are converted into second polar coordinates using the mentioned standard trigonometric methods. The use of the label “second” is used for consistency with the conversions done in the described grid-to-image algorithm, but is arbitrary.

An inverse distortion model is applied to the second polar coordinates to generate first, e.g. “undistorted”, polar coordinates. In examples, the inverse distortion model is based on a tangent model of distortion given by r=f·tan(r′/f), where again r′ is the distorted radial coordinate of the point, r is the undistorted radial coordinate of the point, and f is the focal length of the ultra wide-angle camera. Thus, in examples, the inverse distortion model used in the image-to-grid mapping is an inverse function, or “anti-function”, of the distortion model used in the grid-to-image mapping.

The image-to-grid mapping algorithm continues with converting the first polar coordinates into first cartesian coordinates. The first cartesian coordinates may be de-aligned, or unaligned, with a cartesian coordinate system in the plane corresponding to the ultra wide-angle camera. For example, de-aligning the point with the cartesian coordinate system involves applying a rotational transformation to the point, or a position vector of the point in the plane (e.g. a vector from the origin to the point). The rotation is substantially 90 degrees in examples. This rotation may thus “undo” any “correction” to an offset between the X- and Y-directions of the grid and the horizontal and vertical axes of the captured images previously described in the grid-to-image mapping.

Finally, the point is projected from the (second) plane corresponding to the camera 71 onto the (first) plane corresponding to the grid 15 to determine grid coordinates of the point relative to the grid.

In examples, projecting the point onto the plane corresponding to the grid 15 involves computing p=B⁻¹·(f·t−q·z), where B=q·R_{3,[1,2]}−f·R_{[1,2],[1,2]}. In these equations, p comprises point coordinates in the grid plane, q comprises cartesian coordinates in the camera plane, and f is the focal length of the ultra wide-angle camera as before. Furthermore, t is a planar translation vector, z is a distance (e.g. height) between the ultra wide-angle camera and the grid, and R is a three-dimensional rotation matrix related to a rotation vector. The rotation vector comprises a direction representing the rotation axis of the rotation and a magnitude representing the angle of rotation. The rotation matrix R corresponding to the angle-axis rotation vector can be determined from the vector, e.g. using Rodrigues' rotation formula.

A mathematical derivation of the function for projecting the undistorted 2D point q from the camera plane is now provided for completeness. Beginning with the grid to image projection from above: q=f·p′_{[x,y]}÷p′_{z}, where p′ is the rotated and translated grid point p, i.e. p′=R·p+(tₓ, t_{y}, z)^{T}, we are aiming to derive p from q. Rearranging and substituting for p′ gives:

$${{p}^{′}}_{z} \cdot q = f \cdot {{p}^{′}}_{[ x , y ]} ⇔ {( R \cdot p + {( {t}_{x} , {t}_{y} , z )}^{T} )}_{z} \cdot q = f \cdot {( R \cdot p + {( {t}_{x} , {t}_{y} , z )}^{T} )}_{[ x , y ]} ⇔ ( {( R \cdot p )}_{z} + z ) \cdot q = f \cdot ( {( R \cdot p )}_{[ x , y ]} + t ) ⇔ {( R \cdot p )}_{z} \cdot q + z \cdot q ) = f \cdot {( R \cdot p )}_{[ x , y ]} + f \cdot t ⇔ {( R \cdot p )}_{z} \cdot q - f \cdot {( R \cdot p )}_{[ x , y ]} = f \cdot t - z \cdot q$$

Since the desired distance of the point p on the grid from the camera is given by the height parameter z, it can be assumed in the translation of the point that p_{z}=0. Thus, all p_{z} terms can be removed to leave:

$$( {R}_{3 , [ 1 , 2 ]} \cdot {p}_{[ x , y ]} ) \cdot q - f \cdot {R}_{[ 1 , 2 ] , [ 1 , 2 ]} \cdot {p}_{[ x , y ]} = f \cdot t - z \cdot q ⇔ ( q \cdot {R}_{3 , [ 1 , 2 ]} - f \cdot R ) \cdot {p}_{[ x , y ]} = f \cdot t - z \cdot q$$

By defining a matrix B=(q·R_{3,[1,2]}−f·R), the expression can be further simplified to B. p_{[x,y]}=f·t−z·q, which resolves as the equation above for computing the point p by using the inverse matrix B⁻¹.

Returning to the calibration process 130, in some cases grid cell coordinate data encoded in grid cell markers positioned about the grid 15 can be used to calibrate the computed grid coordinates corresponding to a pixel in a captured image. For example, the grid cell markers are signboards, e.g. placed in predetermined grid cells 17, with corresponding cell coordinate data marked on each signboard. The process 130 includes, for example, processing the captured image to detect a grid cell marker in the image and then extracting the grid cell coordinate data encoded in the grid cell marker to use in calibrating the mapped grid coordinates. Each grid cell marker is located in a respective grid cell, for example located below a respective camera 71 in the field of view 72 thereof.

The image processing may involve using an object detection model, e.g. a neural network, trained to detect instances of grid cell markers in images of grid sections. A computer vision platform, e.g. the Cloud Vision API (Application Programming Interface) by Google®, may be used to implement the object detection model. The object detection model may be trained with images of grid sections including grid cell markers. In examples where the object detection model includes a neural network, e.g. a CNN, the description with reference to FIG. 9 applies accordingly.

The grid coordinates—generated by the mapping of pixels in the captured image to points on the grid section represented in the image—can be calibrated to the entire grid based on the extracted cell coordinate data. For example, the mapped grid point corresponding to a given pixel comprises coordinates in units of grid cells, e.g. (x, y) with a number x of grid cells in the X-direction and a number y of grid cells in the Y-direction. However, the grid cells captured by the camera 71 are of a grid section, i.e. a section of the grid 15, and thus not necessarily the entire grid 15. Thus the mapped grid coordinates (x, y) relative to the grid section captured in the image may be calibrated to grid coordinates (x′, y′) relative to the entire grid based on the relative location of the grid section with respect to the entire grid. The location of the grid section relative to the entire grid can be determined by extracting the grid cell coordinate data encoded in a grid cell marker captured in the image, as described.

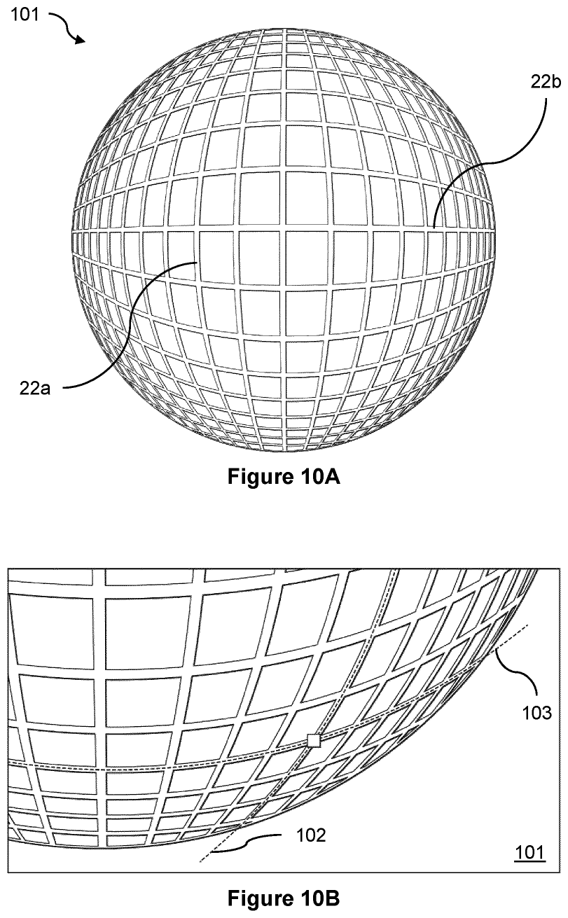

FIG. 10A shows an example model 101 of the tracks generated by processing an image 81 of a grid section, as captured by the ultra wide-angle camera 71, with the trained neural network 90 to detect the tracks 22 in the image. The model 101 comprises a representation of a prediction of the tracks 22a, 22b in the distorted image of the grid section as determined by the neural network 90. Mapping pixels from the track model 101 to corresponding points on the grid 15 can be done to calibrate the camera 71 as described. For example, the calibration involves updating, e.g. optimising, the plurality of parameters associated with the camera 71 that are used for mapping between pixels in the captured images 81, 82 and points on the grid 15.

In examples, the model 101 of the grid section can be refined to represent only centrelines of the first 22a and second 22b sets of parallel tracks. Thus, the pixels to be mapped from the track model 101 to corresponding points on the grid 15 are, for example, pixels lying on a centreline of the first 22a or second 22b sets of parallel tracks in the generated model 101. The refining involves, for example, filtering the model with horizontal and vertical line detection kernels. The kernels allow the centrelines of the tracks to be identified in the model 101, e.g. in the same way other kernels can be used to identify other features of an image such as edges in edge detection. Each kernel is a given size, e.g. a 3×3 matrix, which can be convolved with the image data in the model 101 with a given stride. For example, the horizontal line detection kernel is representable as the matrix:

$$[ \begin{matrix}0 & 0 & 0 \\ 1 & 1 & 1 \\ 0 & 0 & 0\end{matrix} ] .$$

Similarly, the vertical line detection kernel is representable, for example, as the matrix:

$$[ \begin{matrix}0 & 1 & 0 \\ 0 & 1 & 0 \\ 0 & 1 & 0\end{matrix} ] .$$

In examples, the filtering involves at least one of eroding and dilating pixel values of the model 101 using the horizontal and vertical line detection kernels. For example, at least one of an erosion function and a dilation function is applied to the model 101 using the kernels. The erosion function effectively “erodes” away the boundaries of a foreground object, in this case the tracks 22a, 22b in the generated model 101, by convolving the kernel with the model. During erosion, pixel values in the original model (either ‘1’ or ‘0’) are updated to a value of ‘1’ only if all the pixels convolved under the kernel are equal to ‘1’, otherwise it is eroded (updated to a value of ‘0’). Effectively all the pixels near the boundary of the tracks 22a, 22b in the model 101 will be discarded, depending upon the size of kernel used in the erosion, such that the thickness of each of the tracks 22a, 22b decreases to substantially the centreline thereof. The dilation function is the opposite of the erosion function and can be applied after erosion to effectively “dilate” or widen the centreline remaining after the erosion. This dilation can stabilise the centrelines of the tracks 22a, 22b in the refined model 101. During dilation, pixel values are updated to a value of ‘1’ if at least one pixel convolved under the kernel is equal to ‘1’. The erosion and dilation functions are applied respectively to the original generated model 101, for example, with the resulting horizontal centreline and vertical centreline “skeletons” being combined to produce the refined model.

In some cases, the generated model 101 may have missing sections of the tracks 22a, 22b, for example where one or more regions of the grid section viewable by the camera 71 are obscured. Objects on the grid 15 such as transport devices 30, pillars or other structures may obscure parts of the track in the captured image. Thus, the generated model 101 can have the same missing regions of track. Similarly, false positive predictions of the tracks may be present in the generated model 101.

To help with these problems, the tracks 22a, 22b present in the generated model (e.g. the centrelines thereof) can be fitted to respective quadratic equations, e.g. to produce quadratic trajectories for the tracks 22a, 22b. FIG. 10B shows an example of a track of the first set of tracks 22a in the model 101 being fitted to a first quadratic trajectory 102 and a track of the second set of tracks 22b in the model 101 being fitted to a second quadratic trajectory 103. Quadratic track centrelines can then be produced based on the quadratic trajectories, e.g. by extrapolating pixel values along the quadratic trajectories to fill in any gaps or remove any false positives in the model 101. For example, if a sub-line generated from a predicted grid model 101 cannot be fitted to a given quadratic curve together with at least one other line, then it is very unlikely to be part of the grid and should be excluded.

The quadratic equations, y=ax²+bx+c, used for fitting the tracks in the model 101 may also have specified boundary conditions, for example:

$$500 < \frac{- b}{2 a} < 2500 ; - 9.9 \times 1 {0}^{- 4} < a < 9.9 \times 1 {0}^{- 4} ; - 5 < b < 5 ; and 0 < c < 3200 .$$

In examples, a predetermined number of pixels are extracted from the refined model 101 of the tracks, e.g. to reduce the storage requirements to store the model. For example, a random subset of pixels are extracted to give the final refined model 101 of the tracks.

Calibrating the ultra wide-angle cameras 71 using the systems and methods described herein allows for images captured by the cameras 71 with a wide field of view of the grid 15 to be used to detect and localise transport devices thereon, for example. This is despite the relatively high distortion present in the images compared to those of other camera types.

The automatic calibration process outlined above can also reduce the time taken to calibrate each camera 71 installed above the grid 15 of the storage system compared to manual methods of tuning the parameters associated with the respective cameras 71. For example, combining the neural network model, e.g. U-Net, with the customised optimisation function to implement the calibration pipeline as described can remove more than 80% of errors compared to standard calibration methods. Furthermore, the calibration systems and methods described herein have proved to be versatile and consistent enough to calibrate the cameras in multiple warehouse storage systems, e.g. with differing dimensions, scale, and layout.

Furthermore, the output flattened calibrated image 111 of the grid allows for easier interaction with the image 111, both by humans and machines, for monitoring the grid 15 and the transport devices 30 moving thereon. It can therefore be more efficient for instances of unresponsiveness of a given transport device on the grid to be detected and/or acted on to resolve operation of the fleet of transport devices 30.

### Detecting Debris

Provided herein are methods and systems for processing images, e.g. distorted images 81, captured by the one or more cameras 71 to detect debris on the grid 15 of a grid-based storage system 1. For example, a location of the detected debris relative to the grid 15 can be outputted. Examples of debris include items being stored in the containers, spillages of such items, and parts of a transport device. For example, an item being stored in a container may be dropped by the robotic manipulator at a picking station, or fall from a container during transportation of the container in the storage system. Items comprising liquids (e.g. a carton of milk) may cause spillages on the tracks with or without the vessel itself falling onto the tracks. For example, a leaking carton or bottle in a container could cause the contents to spill onto the tracks. In other examples, a transport device 30 may lose a part that falls onto the tracks, e.g. following a crash with another transport device or fixture on the grid such as a picking station.

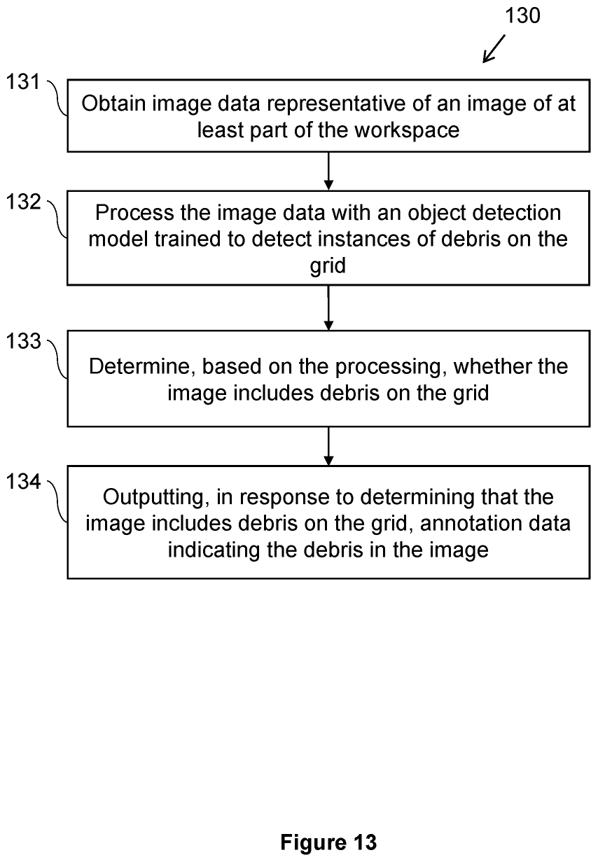

FIG. 13 shows a computer-implemented method 130 of detecting debris on the grid 15. The method 130 involves obtaining 131 and processing 132 image data, representative of an image of at least part of the grid 15, with an object detection model trained to detect instances of debris on the grid. For example, the image is captured by a camera 71 with a field of view 72 covering at least part of the grid 15 and the image data is transferred to the computer for implementing the detection method 130. The image data is received at an interface, e.g. a CSI, of the computer, for example.

The object detection model may be a neural network, e.g. a convolutional neural network, trained to perform object detection of debris on the grid 15 of the workspace. The description of neural networks with respect to FIG. 9 therefore applies in these specific examples. In the present context, the object detection model, e.g. CNN 90, is trained to perform object identification by processing the obtained image data to determine whether an object of a predetermined class of objects (i.e. debris) is present in the image. Training the neural network 90, for example, involves providing training images of workspace sections with picking stations present to the neural network 90. Weight data is generated for the respective (convolutional) layers 92, 94 of a multi-layer neural network architecture and stored for use in implementing the trained neural network. In examples, the object detection model comprises a “You Only Look Once” (YOLO) object detection model, e.g. YOLOv4 or Scaled-YOLOv4, which has a CNN-based architecture. Other example object detection models include neural-based approaches such as RetinatNet or R-CNN (Regions with CNN features) and non-neural approaches such as a support vector machine (SVM) to do the object classification based on determined features, e.g. Haar-like features or histogram of oriented gradients (HOG) features.

The method 130 involves determining 133, based on the processing 132, whether the image includes debris on the grid. For example, the object detection model is configured, e.g. trained or learnt, to detect whether one or more pieces of debris is present in a captured image of the grid 15. In examples, the object detection model makes the determination 133 with a level of confidence, e.g. a probability score, corresponding to a likelihood that the image includes debris on the grid. A positive determination may thus correspond to a confidence level above a predetermined threshold, e.g. 90% or 95%. In response to determining 133 that the image includes the debris, annotation data (e.g. prediction data or inference data) indicative of the predicted debris in the image is output 134. An updated version of the image, including the annotation data, may be output as part of the method 130, for example.

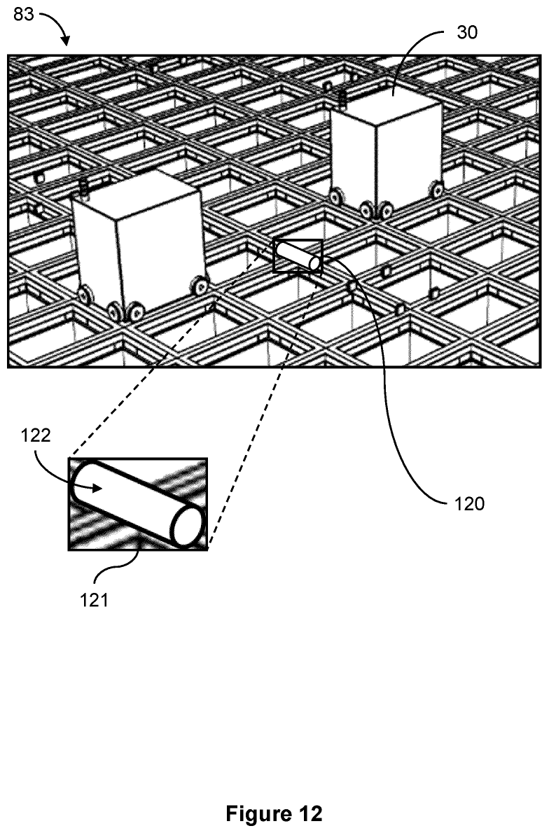

In examples, the annotation data outputted as part of the detection method comprises bounding box data. FIG. 12 shows an example of an updated version 83 of an image, captured by the camera 71, annotated with a bounding box 120 based on bounding box data. The bounding box 120 corresponds to debris 122 detected by the object detection model. A given bounding box comprises a rectangle that surrounds the detected object, for example, and may specify one or more of an image position, identified object class (e.g. debris) and a confidence score (e.g. how likely the object is to be present within the box). Bounding box data defining the given bounding box may include coordinates of two corners of the box or a centre coordinate with width and height parameters for the box in the image 83. In examples, the detection method 130 involves generating the annotation data, e.g. representable as a bounding box 120, for outputting.

In some cases, the object detection model is further trained to classify the debris into one of a plurality of classes of debris. For example, debris may be classified as a storage item (e.g. a stock keeping unit or “SKU”), a spillage, or a bot part. Each class may have further subclasses, for example a storage item may be classified as a genus of storage items such as cartons, bags, tins, etc. The detection method may therefore involve, in response to determining that the image includes debris on the grid, processing the image data with one or more object classification models, trained to classify debris, to determine classification data representative of a class of debris to which the detected debris belongs.

In examples, the detection system causes different responses to the determination that debris is present on the grid depending on the class of debris detected. For example, in response to the classification data being indicative of the detected debris belonging to a first class of debris (e.g. a storage item), the detection system causes deployment of a service device arranged to move on the tracks and comprising a cleaning mechanism with means for removing debris present on the grid. Alternatively, in response to the classification data being indicative of the detected debris belonging to a second class of debris (e.g. a bot part), the detection system causes any transport devices on the grid to be shut down, for example by the master controller.

### Determining an Exclusion Zone

Additionally, or alternatively, to the deployment of a service device for removing the detected debris on the grid (described further below), the detection system may cause an exclusion zone to be set in the workspace. The exclusion zone can be implemented by the master controller of the transport devices 30, for example, and functions to prohibit the transport devices 30 operating in the workspace from entering the exclusion zone. For example, the exclusion zone could be determined around the detected debris, so that the debris can be attended to, e.g. cleaned up or retrieved from the workspace, at a later time. This allows the workspace to remain operational while lowering the risk of other transport devices coming into contact with the debris. In some cases, the determined exclusion zone can be proposed, e.g. to an operator, before implementation, which can help ensure that the determined exclusion zone will cover the actual position of the debris in the workspace.

In examples, the detection method involves determining a target image portion of the captured image based on the annotation data corresponding to the debris detected on the grid. The target image portion is mapped to a target location in the workspace. Based on the mapping, an exclusion zone in the workspace is determined into which one or more transport devices are to be prohibited from entering. The exclusion zone includes the target location mapped from the target image portion. Exclusion zone data, representative of the exclusion zone, is output to a control system, e.g. the master controller of the transport devices, for implementing the exclusion zone in the workspace.

In examples, the target image portion includes at least part of a debris object in the workspace. For example, the target image portion is a subset of one or more pixels selected from the image of the workspace captured by the image sensors. The one or more pixels correspond to at least part of a debris object present in the captured image of the workspace. For example, the target image portion includes a whole debris object present in the image. In other examples, the target image portion is only a single pixel corresponding to a part of the debris object present in the image.

The target image portion is obtained from the object detection system configured to detect debris present on the grid from images of the workspace. For example, the process involves the object detection system obtaining the image of the workspace captured by the camera and determining, using an object classification model, that debris on the grid is present in the image data. The object classification model, e.g. object classifier, comprises a neural network in examples, as described in general with reference to FIG. 9, which is taken to apply accordingly. For example, the object classifier is trained with a training set of images of debris in the workspace to classify images subsequently captured by the image sensors as containing debris in the workspace or not.

For positive classifications by the trained object classifier, the object detection system can then output the target image portion. For example, the object detection system may indicate the target image portion in the original image captured by the camera, e.g. using annotation data such as a bounding box. Alternatively, the object detection system outputs the target image portion as a cropped version of the original input image received from the image sensors, the cropped version including the identified debris in the workspace.

In examples, the object detection system comprises a neural network trained to detect debris and its location in the image data. For example, the object detection system determines a region of the input image in which debris is present. The region can then be output as the target image portion, for example. In such cases, the training of the neural network involves using annotated images of the workspace indicative of debris in the workspace. The neural network is thus trained to both classify an object in the workspace as debris, and to detect where the debris is in the image, i.e. to localise the debris relative to the image of the workspace.

As described herein, the target image portion output by the object detection system may include at least part of a debris object in the workspace. For example, the target image portion is a subset of one or more pixels selected by the object detection system, e.g. on the basis of a positive localisation of the debris object, from the image captured by the camera.

In examples, the determined exclusion zone comprises a discrete number of grid spaces, e.g. a plurality of grid cells adjacent to the debris detected on the grid. For example, where the debris is detected at a junction of the transverse tracks, the determined exclusion zone may comprise the four grid cells adjoining the junction. Alternatively, where the debris is detected along a single portion of track, the determined exclusion zone may comprise the two grid cells either side of the track portion. In both cases, transport devices operating on the grid are prohibited from entering the exclusion zone, when implemented, and thus can avoid contacting the debris on the part of the tracks required to access the excluded grid cells.

In some examples, the exclusion zone may be increased to include a buffer area around the affected grid cells where the debris is located. In such cases, the buffer area can improve the effectiveness of the exclusion zone versus only excluding the directly adjacent grid cells to the mapped location of the debris on the grid. The size of the buffer area may be predetermined, e.g. as a set area of grid cells to be applied once the immediate grid cells for exclusion are determined. Additionally or alternatively, the size of the buffer area is a selectable parameter when implementing the exclusion zone at the control system.

The control system, e.g. master controller, which remotely controls movement of the transport devices operating in the workspace can implement the exclusion zone based on the exclusion zone data output as part of the method. For example, each of the one or more transport devices 30 is remotely operable under the control of the master control system, e.g. central computer. Instructions can be sent from the master control system to the one or more transport devices 30 via a wireless communications network, e.g. implementing one or more base stations, to control movement of the one or more transport devices 30 on the grid 15.

A controller in each transport device 30 is configured to control various driving mechanisms of the transport device, e.g. vehicle 32, to control its movement. For example, the instruction includes various movements in the X-Y plane of the grid structure 15, which may be encapsulated in a defined trajectory for the given transport device. The exclusion zone can thus be implemented by the central control system, e.g. master controller, so that the defined trajectories avoid the exclusion zone represented by the exclusion zone data. For example, when the exclusion zone is implemented, one or more respective trajectories corresponding to one or more transport devices 30 on the grid are updated to avoid the exclusion zone.

In examples, mapping the target image portion (e.g. one or more pixels in the image) to the target location (e.g. a point on the grid structure) involves inversing a distortion of the image of the workspace. For example, where the camera comprises a wide-angle or ultra wide-angle lens, the lens distorts the view of the workspace. Thus, the distortion is inversed, for example, as part of the mapping between the image pixels and grid points. An inverse distortion model may be applied to the target image portion for this purpose. The discussion of an image-to-grid mapping algorithm in earlier examples applies here accordingly. For example, mapping the target image portion to the target grid location involves applying the image-to-grid mapping algorithm described herein.

In some examples, a check is made as to whether the debris has been cleared from the grid so that the exclusion zone can be lifted, e.g. cancelled, such that the transport devices are free to enter the corresponding grid cells. For example, further image data, representative of a further image of at least part of the workspace, is obtained and processed with the object detection model trained to detect instances of debris on the grid. It is determined, based on the processing, whether the further image includes debris on the grid. In response to determining that the further image does not include debris on the grid, the exclusion zone is caused to be lifted, e.g. by a signal sent to the master controller.

An assistance system may be implemented for assisting the control system to control transport device movement in the workspace. The object detection system configured to detect debris in the workspace is part of the assistance system, for example. An interface of the assistance system may obtain the target image portion from the object detection system, as described in examples. The assistance system is configured, for example, to perform the mapping of the target image portion to the target location in the workspace, determining the exclusion zone, and outputting the exclusion zone data. For example, the assistance system outputs the exclusion zone data for the control system, e.g. master controller, to receive as input and implement in the workspace. The exclusion zone data may be transferred directly between the assistance system and the control system or may be stored by the assistance system in storage accessible by the control system.

In embodiments employing the assistance system, the assistance system may be incorporated into the storage system 1, e.g. the example shown in FIG. 7A, which includes the workspace and control system for controlling transport device movement in the workspace. As described in examples with reference to FIG. 7A, the workspace includes a grid 15 formed by a first set 22a of parallel tracks extending in an X-direction, and a second set 22b of parallel tracks extending in a Y-direction transverse to the first set in a substantially horizontal plane. The grid 15 includes multiple grid spaces 17 and the one or more transport devices 30 are arranged to selectively move around on the tracks to handle a container 10 stacked beneath the tracks 22 within a footprint of a single grid space 17. Each transport device 30 may have a footprint that occupies only a single grid space 17 so that a given transport device occupying one grid space does not obstruct another transport device occupying or traversing adjacent grid spaces.

In some cases, e.g. instead of implementing an exclusion zone around the detected debris, a signal is sent to the master controller, in response to determining that the image includes debris on the grid, to cause the master controller to shut down the one or more transport devices. As described in earlier examples, the shutdown option may be taken based on detecting a particular class of debris on the grid, e.g. where further classification of the debris is performed.

### Deploying a Service Device

As described in some examples, a robotic service device may be deployed for removing the detected debris from the grid. For example, the detection method involves determining a target image portion of the image based on the annotation data and mapping the target image portion to a target location in the workspace (as described in other examples). A signal is output for deploying a service device to the target location in the workspace, e.g. on the grid. The service device is arranged to selectively move in at least one of the first or second directions on the tracks. For example, the service device comprises, similarly to the transport devices, a body mounted on two sets of wheels: a first set of wheels being arranged to engage with at least two tracks of the first set of tracks, and a second set of wheels being arranged to engage with at least two tracks of the second set of tracks. The first set of wheels are independently moveable and driveable with respect to the second set of wheels such that only one set of wheels is engaged with the grid at any one time, thereby enabling movement of the service device along the tracks to any point on the grid by driving only the set of wheels engaged with the rails. The robotic service device is provided with features additional to those of the robotic transport devices, namely the service device comprises a cleaning mechanism comprising means for removing debris present on the grid. For example, the cleaning mechanism comprises at least one of a vacuum cleaning system (e.g. mounted adjacent to each set of wheels), a brush mechanism (e.g. comprising one or more brushes), and a spray device capable of discharging suitable detergent adapted to deal with contaminants on the grid.

### Picking Stations

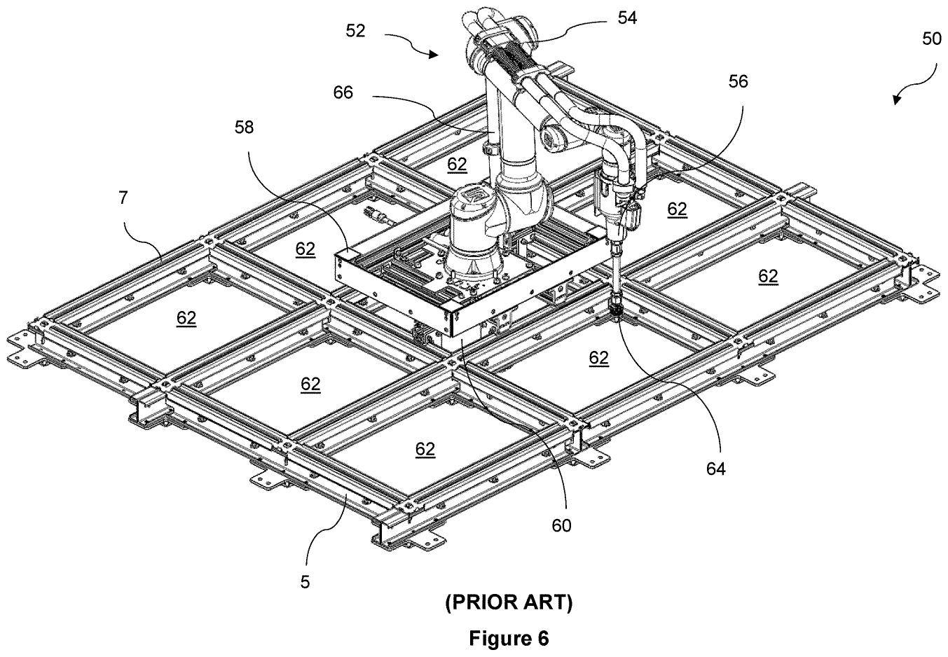

As described with reference to FIG. 6, the system may further comprise one or more robotic picking stations 50 mounted on top of the grid-based storage system 1.

FIG. 7B shows a schematic depiction of the detection system in this context. The grid-based storage system 1 is of the type previously described, e.g. an automated storage and retrieval system (or “ASRS”). In this embodiment, there are multiple robotic picking stations 50 mounted on top of the grid-based storage system 1, e.g. mounted on the grid structure (or simply “grid”) 15 as previously described with reference to FIG. 6. Each picking station 50 comprises a robotic manipulator 52 to transfer items between containers received in designated grid cells adjacent to the respective picking station 50. For example, the robotic manipulator 52 includes an end effector for releasably engaging the items to be manipulated and transferred between containers. The end effector may be a suction device connected to a vacuum source, as per the embodiment shown in FIG. 7B, or another type of end effector such as a jaw gripper or a finger gripper.

In the embodiment shown in FIG. 7B, each robotic manipulator 52 is mounted on a plinth above a single grid cell and is surrounded by eight grid cells. In other embodiments, a given robotic manipulator 52 may be surrounded by fewer grid cells or on fewer sides, depending on the location on the storage system 1. Similarly, FIG. 7B shows the robotic picking stations 50 arranged along both of the orthogonal directions of the grid 15, however, in other embodiments the picking stations 50 may be arranged along only one axis of the grid 15, e.g. in a row or line. In some cases, there may be clusters of robotic picking stations 50 arranged at selected locations on the grid 15 of the storage system 1. Disposed above the grid 15 is the camera 71 forming part of the detection system as described in the other examples.

In this context, the detection systems and methods may determine whether debris detected on the grid is located on a portion of the tracks adjacent to one or more designated grid cells of a robotic picking station 50 mounted on the grid 15. For example, a target image portion of the image is determined, based on the annotation data output from the initial detection, and mapped to a target location in the workspace as described in other examples. Based on the mapping, e.g. the determined location of the debris relative to the grid, it is determined whether the debris is located on a portion of the tracks adjacent to one or more grid cells associated with a given picking station 50. In response to a positive determination, a signal is outputted to cause the robotic manipulator 52 of the given picking station 50 to remove the debris from the tracks.

The previously described detection system may be configured to perform any of the detection methods described herein. For example, the detection system includes an image sensor to capture the images of at least part of the grid and an interface to obtain the image data. The detection system includes the trained object detection model, e.g. implemented on a graphics processing unit (GPU) or a specialised neural processing unit (NPU), to carry out the processing and determining steps of the computer-implemented method 130 of detecting debris 122 on the grid 15.

The above examples are to be understood as illustrative examples. Further examples are envisaged. For example, the cameras 71 disposed above the grid 15 have been described as ultra wide-angle cameras in many examples. However, the cameras 71 may be wide-angle cameras, which include a wide-angle lens having a relatively longer focal length than an ultra wide-angle lens, but still introduces distortion compared with a normal lens that reproduces a field of view which appears “natural” to a human observer.

Similarly, the described examples include obtaining and processing “images” or “image data”. Such images may be video frames in some cases, e.g. selected from a video comprising a sequence of frames. The video may be captured by the camera positioned above the grid as described herein. Thus, the obtaining and processing of images should be interpreted to include obtaining and processing video, e.g. frames from a video stream. For example, the described neural networks may be trained to detect instances of objects (e.g. debris) in a video stream comprising a plurality of images.

In examples employing storage to store data, the storage may be a random-access memory (RAM) such as DDR-SDRAM (double data rate synchronous dynamic random-access memory). In other examples, the storage 330 may include non-volatile memory such as Read-Only Memory (ROM) or a solid-state drive (SSD) such as Flash memory. The storage in some cases includes other storage media, e.g. magnetic, optical or tape media, a compact disc (CD), a digital versatile disc (DVD) or other data storage media. The storage may be removable or non-removable from the relevant system.

In examples employing data processing, a processor can be employed as part of the relevant system. The processor can be a general-purpose processor such as a central processing unit (CPU), a microprocessor, a graphics processing unit (GPU), a digital signal processor (DSP), an application-specific integrated circuit (ASIC), a field-programmable gate array (FPGA) or another programmable logic device, a discrete gate or transistor logic, discrete hardware components, or any suitable combination thereof designed to perform the data processing functions described herein.

In examples involving a neural network, a specialised processor may be employed as part of the relevant system. The specialised processor may be an NPU, a neural network accelerator (NNA) or other version of a hardware accelerator specialised for neural network functions. Additionally or alternatively, the neural network processing workload may be at least partly shared by one or more standard processors, e.g. CPU or GPU.

Although the term “annotation data” has been used throughout the description, the term is envisaged to correspond with prediction data or inference data in alternative nomenclature. For example, the object detection model (e.g. comprising a neural network) may be trained using annotated images, e.g. images with annotations such as bounding boxes, which serve as a ground truth for the model, e.g. a prediction or inference with a confidence of 100% or 1 when normalised. These annotations may be made by a human for the purposes of training the model, for example. Thus, the object detection of the present disclosure can be taken to involve outputting prediction data or inference data (e.g. instead of “annotation data”) to indicate a prediction or inference of the debris in the image. The prediction data or inference data may be represented as an annotation applied to the image, e.g. a bounding box and/or a label. The prediction data or inference data includes a confidence associated with the prediction or inference of the debris in the image, for example. The annotation can be applied to the image based on the generated prediction data or inference data, for example. For instance, the image may be updated to include a bounding box surrounding the predicted debris with a label indicating the confidence level of the prediction, e.g. as a percentage value or a normalised value between 0 and 1.

It is also to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

1. A computer-implemented method of detecting debris in a workspace comprising a grid formed by a first set of tracks extending in a first direction and a second set of tracks extending in a second direction transverse to the first direction,
the method comprising:
obtaining image data representative of an image of at least part of the workspace;
processing the image data with an object detection model trained to detect instances of debris on the grid;
determining, based on the processing, whether the image includes debris on the grid; and
in response to determining that the image includes debris on the grid, outputting annotation data indicative of the debris in the image.

2. A method according to claim 1, wherein the method comprises generating the annotation data.

3. A method according to claim 1, wherein the method comprises outputting an updated version of the image including the annotation data.

4. A method according to claim 1, wherein the annotation data comprises a bounding box.

5. A method according to claim 1, wherein the object detection model comprises a convolutional neural network.

6. A method according to claim 1, wherein one or more transport devices are arranged to selectively move in at least one of the first or second direction on the tracks, and to handle a container stacked beneath the tracks within a footprint of a single grid cell,
the method comprising:
determining a target image portion of the image based on the annotation data;
mapping the target image portion to a target location in the workspace;
determining, based on the mapping, an exclusion zone in the workspace, comprising the target location, in which the one or more transport devices are to be prohibited from entering; and
outputting, to a control system, exclusion zone data representative of the exclusion zone for implementing the exclusion zone in the workspace.

7. A method according to claim 6, wherein the exclusion zone comprises a plurality of grid cells adjacent to the debris detected on the grid.

8. A method according to claim 6, comprising:
obtaining further image data representative of a further image of the at least part of the workspace;
processing the further image data with the object detection model;
determining, based on the processing, whether the further image includes debris on the grid; and
causing, in response to determining that the further image does not include debris on the grid, the exclusion zone to be lifted.

9. A method according to claim 1, wherein one or more transport devices are arranged to selectively move in at least one of the first or second direction on the tracks, and to handle a container stacked beneath the tracks within a footprint of a single grid cell,
the method comprising:
outputting, in response to determining that the image includes debris on the grid, a signal to a master controller of the one or more transport devices to cause the master controller to shut down the one or more transport devices.

10. A method according to claim 1, comprising:
determining a target image portion of the image based on the annotation data;
mapping the target image portion to a target location in the workspace; and
outputting a signal for deploying a service device to the target location, the service device being arranged to selectively move in at least one of the first or second direction on the tracks and comprising a cleaning mechanism with means for removing debris present on the grid.

11. A method according to claim 1, wherein the workspace comprises one or more picking stations mounted on the grid, each picking station comprising a robotic manipulator to transfer items between containers received in respective grid cells adjacent the picking station,
the method comprising:
determining a target image portion of the image based on the annotation data;
mapping the target image portion to a target location in the workspace;
determining, based on the mapping, whether the debris detected on the grid is located on a portion of the tracks adjacent to one or more grid cells associated with at least one of the one or more picking stations; and
outputting a signal, in response to determining that the debris is located on a portion of the tracks adjacent to one or more grid cells associated with a given picking station of the one or more picking stations, to cause the robotic manipulator of the given picking station to remove the debris from the tracks.

12. A method according to claim 1, wherein the method comprises:
processing, in response to determining that the image includes debris on the grid, the image data with one or more object classification models trained to classify debris; and
determining classification data, representative of a class of debris to which the detected debris belongs, based on the processing.

13. A method according to claim 12, comprising:
deploying, in response to the classification data being indicative of the detected debris belonging to a first class of debris, a service device arranged to move on the tracks and comprising a cleaning mechanism with means for removing debris present on the grid; or
shutting down, in response to the classification data being indicative of the detected debris belonging to a second class of debris, any transport devices on the grid, the transport devices being arranged to move on the tracks to transport containers, stacked beneath the tracks, between grid cells.

14. A data processing apparatus comprising means for carrying out the method of claim 1.

15. (canceled)

16. (canceled)

17. A detection system to detect debris in a workspace comprising a grid formed by a first set of tracks extending in a first direction and a second set of tracks extending in a second direction transverse to the first direction,
the detection system comprising:
an image sensor to capture an image of at least part of the workspace; and
an object detection model trained to detect instances of debris on the grid;
wherein the detection system is configured to:
obtain image data representative of the image;
process the image data with the object detection model;
determine, based on the processing, whether the image includes debris on the grid; and
output, in response to determining that the image includes debris on the grid, annotation data indicative of the debris in the image.

18. A detection system according to claim 17, wherein the detection system includes a wide-angle or ultra wide-angle camera comprising the image sensor.

19. A detection system according to claim 18, wherein the object detection model comprises a convolutional neural network.
